(19) United States
(12) Patent Application Publication
(10) Pub. No.: US 2006/0174294 A1
(43) Pub. Date: Aug. 3, 2006

(54) Digital broadcasting receiver for receiving analog broadcasting and a method thereof

(75) Inventors: Kyoung-su Kim, Suwon (KR); Jae-kyoung Shim, Suwon (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/319,579

(22) Filed: Dec. 29, 2005

Related U.S. Application Data
(63) Continuation of application No. 09/177,815, filed on Oct. 23, 1998.

(30) Foreign Application Priority Data
Oct. 23, 1997 (KR) 54345/1997

(51) Int. Cl. H04N 7/173; H04N 7/16

(52) U.S. Cl. 725/90; 725/100; 725/131; 725/151

(57) ABSTRACT

A broadcasting receiver of a display receiver and method thereof receives a digital broadcasting signal and an analog broadcasting signal. A tuning unit selectively receives the digital and analog broadcasting signals. A processing unit processes the digital and analog broadcasting signals in accordance with the selection by said tuning unit, and includes an additional information processing unit to generate additional information corresponding to the digital and analog broadcast signals, and a video mix unit to selectively output the processed digital broadcasting signal with the additional information and the processed analog broadcasting signal with the additional information. The additional information corresponding to the digital broadcasting signal and the analog broadcasting signal are the same.

### CROSS-REFERENCE TO RELATED APPLICATIONS

This application claims the benefit pending U.S. application Ser. No. 09/177,815, filed Oct. 23, 1998, which claims the benefit of Korean Application No. 54345/1997, filed Oct. 23, 1997, in the Korean Patent Office, the disclosures of which are incorporated herein by reference.

### BACKGROUND OF THE INVENTION

1. Field of the Invention

The present invention relates to a digital broadcasting receiver for receiving analog broadcasting and a method thereof, and more particularly, relates to a digital broadcasting receiver for receiving analog broadcasting and a method thereof by selectively receiving analog broadcasting or digital broadcasting, according to a selection of a user in a digital satellite broadcasting receiver or a digital cable broadcasting receiver using a digital transmission system such as a high definition television.

2. Description of the Related Art

Nowadays, a data (information) transmission system is being changed from an analog type to a digital type due to technical improvements of information media.

In order, to meet the requirement for transmitting an utmost amount of information within the same time, the data is compressed and transmitted using a data compressing rule, such as an MPEG.

The International Standard Organization (ISO) standardizes the MPEG as a standardized coding (compressing) system, related to a digital motion picture coding system, an acoustic coding system and a multiplexing and separating system, for communication, broadcasting, media for storing data, and computer fields.

The MPEG compresses an audio visual such as an acoustic signal, a motion picture, and a still image at a high rate and transmits the same. The advantages of using the MPEG are provided hereinafter. For example, it is possible to obtain a multi-channeling and high-definition transmission effect in the broadcasting. An occupied amount of the media for storing data can be reduced. Multimedia information can be stored in a low-priced storing medium. And, multimedia communication is cheaply executed in the multimedia communication field. Accordingly, MPEG has become a core technology in the recent multimedia era.

In the mean time, generally, a television receiver is standardized for processing an analog broadcasting signal. For receiving a digital broadcasting signal in an analog-type television receiver, according to spreading a satellite broadcasting system and other digital broadcasting systems, a digital broadcasting receiver, that is an additional converting apparatus, called a ‘Digital Set Top Box’, for converting the compressed and transmitted digital broadcasting signal, according to the MPEG rule, in the analog broadcasting signal is required.

The digital broadcasting receiver converts the digital-type video signal from a program supplier or a service supplier, that is, each broadcasting station such as a satellite broadcasting station and a cable broadcasting station such as a cable television broadcasting station, into the analog-type video signal. That is, the digital broadcasting receiver can convert the digital broadcasting system into the broadcasting system for processing the signal in the general television receiver. Recently, the digital broadcasting receivers are widely utilized according to the desire of the user to view the digital-type broadcasting signal.

Accordingly, as is well known, after converting programs from the analog signal into the digital signal, each broadcasting station or cable broadcasting station supplies the programs. For transmitting a large amount of information, the converted data is compressed by a predetermined compression rule and transmitted to a viewer via a communication network.

The digital broadcasting receiver receives the transmitted digital data and displays the analog signal on a monitor after converting the digital data into the analog signal at the viewer's side.

As mentioned above, FIG. 1 is an apparatus for processing the digital signal, which is compressed and transmitted by each broadcasting station or cable broadcasting station, to the analog signal and displaying the analog signal.

The apparatus shown in FIG. 1 will be described hereinafter as an example of a conventional digital broadcasting receiver.

As shown in FIG. 1, the digital broadcasting receiver includes: a digital broadcasting tuner 101, which tunes a compressed hybrid carrier signal, which is transmitted from the broadcasting station or the cable broadcasting station and input via an input terminal 100, to a frequency of a relevant channel and changes an amplitude of the tuned carrier signal in proportion to a size of a phase shift modulation signal; a diplexer 102 for eliminating a mutual interference between the video signal and the audio signal of the tuned carrier signal tuned by the digital broadcasting tuner 101; a filter unit 103 for extracting a digital signal band by filtering the tune carrier signal, obtained from the diplexer 102; an analog to digital (A/D) converting unit 104 for converting the analog signal from the tuned carrier signal into the digital signal of the tuned carrier signal and outputting the same; a demodulation unit 105 for restoring digital data, obtained from the A/D converting unit 104, to initial data; an automatic error correcting unit 106 for correcting the error generated from the interference between adjacent channels, which corrects a carrier data format, demodulated and input by the demodulation unit 105, based on residue information, and outputs the same by a packet unit; an MPEG process unit 107 which MPEG processes the video data and the audio data, which are input after the error is corrected, stores the same in a memory unit 109, and additionally, converts the same to an initial composite video signal CPSV and an audio signal ADS and respectively outputs the composite video signal CPSV and the audio signal ADS to a video output terminal 111 and an audio output terminal 112; and a high frequency modulation unit 108, for modulating the digital composite video signal CPSV and the audio signal ADS, which are restored by the MPEG process unit 107, to the high frequency signal and supplies the high frequency signal to a television receiver via an output terminal 110.

In the conventional digital broadcasting receiver having the above-mentioned structure, when the compressively hybridized digital video signal and the audio signal, which are related to the program from the broadcasting station or the cable broadcasting station, are input as a carrier signal via the input terminal 100, the digital broadcasting tuner 101 tunes the input and compressed hybrid carrier signal via the input terminal 100 to the frequency of a relevant channel and changes the amplitude of the tuned carrier signal in proportion to the size of the phase shift modulation signal.

The diplexer 102 receives the amplitude-changed carrier signal via the digital broadcasting tuner 101. The diplexer 102 eliminates the mutual interference between the video signal and the audio signal, among the tuned carrier signals via the digital broadcasting tuner 101, and supplies the interference-eliminated signals to the filter unit 103.

In the mean time, the filter unit 103 filters out the input carrier signal from the diplexer 102 and detects only a digital signal band, that is a band from 450 MHz to 700 MHz. The carrier signal having an analog characteristic, detected via the filter unit 103, is converted into a digital signal via the analog/digital converting unit 104 and is supplied to the demodulation unit 105. The carrier data, restored by the demodulation unit 105, of which an error, generated by the interference between the adjacent channels, is corrected by the automatic error correcting unit 106, and supplied to the MPEG process unit 107 as initial audio and video packet data.

Accordingly, the MPEG process unit 107 stores the video data and the audio data, which are input from the automatic error correcting unit 106, to the memory unit 109, MPEG processes the initial composite video signal CPSV and the audio signal ADS, respectively outputs the composite video signal CPSV and the audio signal ADS via the video output terminal 111 and the audio output terminal 112 and supplies the composite video signal CPSV and the audio signal ADS to the high frequency modulation unit 108.

The high frequency modulation unit 108 modulates the composite video signal CPSV and the audio signal ADS, which are MPEG processed, and supplies the same to the television receiver via the output terminal 110. Accordingly, the viewer can see the digital broadcasting via a color cathode ray tube. The composite video signal and the audio signal, which are respectively output to the video output terminal 111 and the audio output terminal 112, are supplied to a digital video disk player or a digital video cassette recorder and stored in a magnetic recording medium.

But, as is well known, when the received broadcasting signal and the received cable broadcasting signal are the digital broadcasting signal, the above-mentioned conventional digital broadcasting receiver receives the broadcasting signal and displays the same on the television receiver. When the received broadcasting signal is an air broadcasting signal or the analog cable broadcasting, the digital broadcasting receiver cannot receive the analog signal directly.

Accordingly, the conventional digital broadcasting receiver cannot receive the analog signal, which is transmitted from the air broadcasting or the cable broadcasting. Consequently, it is a problem to receive the analog broadcasting signal via the digital broadcasting receiver.

Accordingly, a digital broadcasting receiver, which can receive both the analog/digital broadcasting, with respect to the air broadcasting or the analog cable broadcasting and having a higher quality than that of the conventional digital broadcasting receiver, is required.

### SUMMARY OF THE INVENTION

Therefore, it is an object of the present invention to provide a method and apparatus for receiving an analog broadcasting using a digital broadcasting receiver selectively receiving analog broadcasting and digital broadcasting and displaying the same on a screen by using the one digital broadcasting receiver.

It is another object of the present invention to provide an additional information screen with respect to the same in receiving the digital broadcasting, in a case that the analog broadcasting is received.

It is still another object of the present invention to prevent poor display results when alternating between viewing a digital broadcast an analog broadcast.

It is a further object of the present invention to provide an apparatus which corresponds to a product that requires as outputs a composite video signal, a luminance/color and a high frequency modulation.

Additional objects and advantages of the invention will be set forth in part in the description which follows and, in part, will be obvious from the description, or may be learned by practice of the invention.

According to one aspect of the present invention, the digital broadcasting receiver extracts a digital band from a carrier signal, tuned by a digital broadcasting tuner, passes through the extracted digital band via a quadrature phase shift demodulation unit, a forward direction error correcting unit and a reverse multiplexing unit, restores video data and audio data by an MPEG audio/video process unit and outputs the same. The digital broadcasting receiver for receiving analog broadcasting includes a controller, which generates more than two control signals having respectively different information, to receive analog or digital broadcasting, according to a selection of an analog broadcasting channel or a digital broadcasting channel; a digital broadcasting turner to receive the analog or digital broadcasting channel according to the selection; an air tuner for receiving the analog broadcasting signal according to the selection of the controller; a synchronous separation unit for extracting a synchronous signal from the analog broadcasting signal, received from the air tuner; an additional information process unit for generating additional information according to a first one of the control signals of the controller; a video encoder unit, which encodes, according to a second one of the control signals generated from the controller and the synchronous signal, a video signal and the additional information into an encoded analog video signal; a video mix unit for mixing the analog video signal from the air tuner and the encoded analog signal and transmitting the mixed signal; a digital/analog converting unit for converting the audio signal, which is obtained from the MPEG audio/video process unit, to an audio analog signal; and an audio selection unit for selecting and transmitting the converted audio signal and the audio signal which is obtained from the air tuner according to a third one of the control signals of the controller.

Preferably, the digital broadcasting receiver for receiving the analog broadcasting further includes a luminance/color separation unit for separating the mixed signal transmitted by the video mix unit into a luminance signal and a color signal and transmitting the separated mixed signal.

Preferably, the video mix unit overlaps the additional information, of the video encoder unit, with the analog video signal, received from the air tuner, and transmits the overlapped analog video signal.

The digital broadcasting receiver for receiving the analog broadcasting may further include a luminance/color separation unit for separating the analog video signal which is received from a air tuner into a luminance signal and a color signal; and a switching unit to detect and change the separated luminance signal to a continuous signal, and transmit the continuous signal and the color signal.

Moreover, selectively, the video mix unit includes a switcher, wherein the switcher maps the additional information other than a transparency between the encoded MPEG processed analog signal, obtained from the video encoder unit, and the analog video signal, received from the air tuner, and outputs the mapped additional information.

According to another aspect of the present invention, a method of receiving an analog broadcasting signal and a digital broadcasting signal using a digital broadcasting receiver comprises the steps of selecting one of a digital broadcasting channel and an analog broadcasting channel using a digital broadcasting tuner and an air tuner; tuning the air tuner, receiving the analog broadcasting signal of the corresponding analog broadcasting channel and extracting the synchronous signal from the received analog broadcasting signal, in the case that the selected broadcasting channel is the analog broadcasting channel; tuning the digital broadcasting tuner, receiving the digital broadcasting signal of the corresponding digital broadcasting channel via the digital broadcasting tuner and separating the digital broadcasting signal to an MPEG processed video signal and an MPEG processed audio signal using MPEG processing, in the case that the selected broadcasting channel is the digital broadcasting channel; selectively encoding the MPEG processed video signal and predetermined additional information, according to the extracted synchronous signal; selectively transmitting the additional information overlapped within the video signal separated from the analog broadcasting signal, and the video signal additional information overlapped with the MPEG processed separated from the digital broadcast signal in accordance with the MPEG processed separated from the digital broadcast signal in accordance with the encoding selected in the encoding step and selectively transmitting the MPEG processed audio signal separated from the digital broadcast signal and the analog broadcasting audio signal separated from the analog broadcasting signal.

Preferably, when the selected channel is the digital broadcasting channel in the selective encoding step, the additional information is overlapped with the MPEG processed video signal and encoded. In the mean time, when the selected channel is the analog broadcasting channel, the additional information is encoded.

Also, preferably, when the selected channel is the digital broadcasting channel in the selective transmitting step, the MPEG processed video signal and the additional information, which are overlapped, are selected and transmitted. In the mean time, when the selected channel is the analog broadcasting channel, the additional information is overlapped with the analog broadcast video signal separated from the analog broadcasting signal and transmitted.

Moreover, preferably, when the selected channel is the analog broadcasting channel in the transmitting step, information of the additional information which does not include a transparency is mapped onto the analog broadcast video signal and transmitted.

In this manner, by receiving the analog broadcasting signal and the digital broadcasting signal via one digital broadcasting receiver, the user can see one of the analog and digital broadcasting signals on the screen of the television receiver, selectively, and the additional information received with the analog broadcasting signal, that is the same as with receiving the digital broadcasting signal.

Consequently, by receiving the analog broadcasting signal and the digital broadcasting signal via one broadcasting receiver, the present invention provides convenience in use and compatibility with the television receiver.

It is possible for the present invention to have a plurality of preferred embodiments and the most preferred embodiment of the present invention will be described hereinafter.

### BRIEF DESCRIPTION OF THE DRAWINGS

A more complete appreciation of the present invention, and may of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a conventional digital broadcasting receiver; and

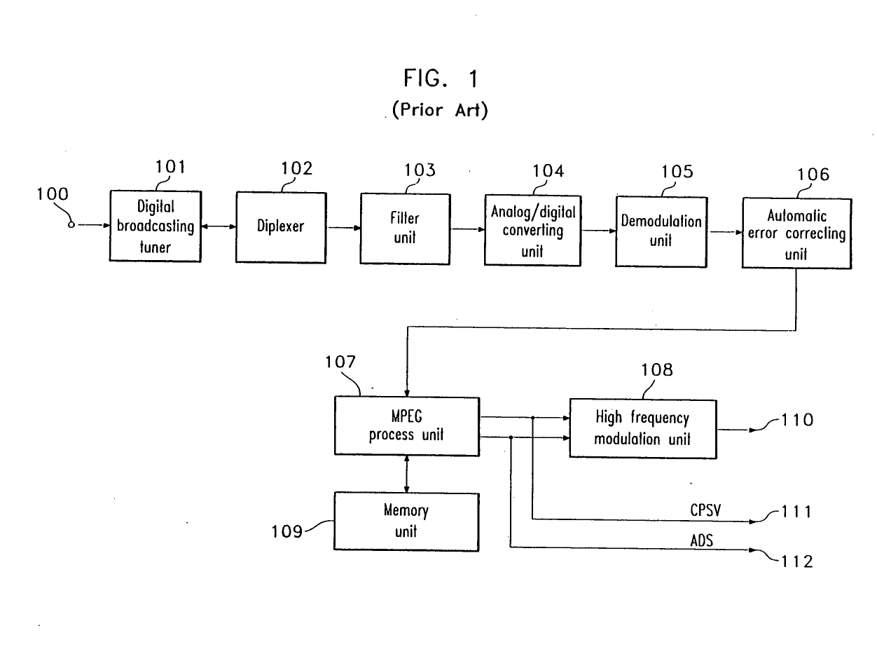

FIG. 2 is a block diagram of a digital broadcasting receiver for receiving an analog broadcasting, according to an embodiment of the present invention.

### DETAILED DESCRIPTION OF THE PREFERRED EMBODIMENT

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

The preferred embodiment of a digital broadcasting receiver for receiving an analog broadcasting will be more clearly understood through the attached drawings.

In the following description, when the detailed description related to disclosed function and structure is unnecessarily obvious to the substance of the present invention, the detailed description will be emitted.

Moreover, the present invention can be applicable to various apparatuses for receiving the digital broadcasting, such as a high definition television receiver, a high definition video cassette recorder having a tuner, etc.

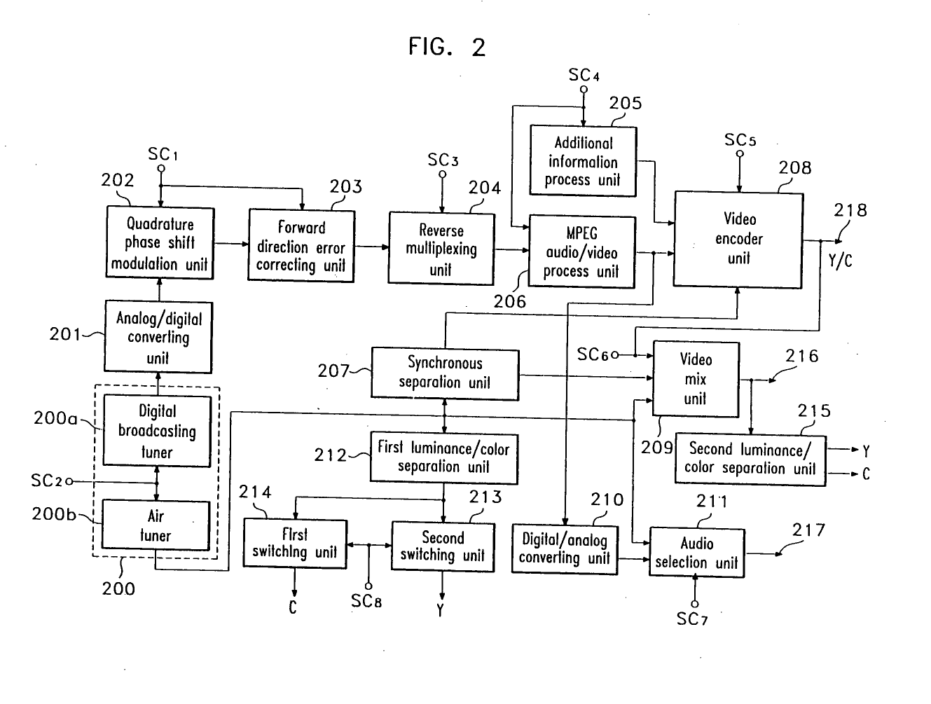

Accordingly, FIG. 2 is a block diagram of a digital broadcasting receiver for receiving both an analog broadcasting and a digital broadcasting and displaying the same on a screen. As a result, the screen is not a digital broadcasting receiver for only receiving the digital broadcasting.

Moreover, in the following description, receipt of the analog broadcasting by the digital broadcasting receiver will be considered.

According to a preferred embodiment, a digital broadcasting receiver for receiving digital/analog broadcasting includes a controller 219 which determines whether an analog or digital broadcasting channel is selected, by a remote controller 219 or a set-mounted channel key, and generates corresponding first through eighth control signals; a tuning unit 200 receives the digital broadcasting channel via a digital broadcasting tuner 200a, according to the second control signal CS2, and receives the analog broadcasting channel via the air tuner 200b, according to the second control signal CS2; and an analog/digital converting unit 201 converts a modulated and received carrier signal into a digital signal, wherein the carrier signal is modulated in a quadrature phase shift keying manner via the digital broadcasting tuner 200a.

The digital broadcasting receiver further comprises a quadrature phase shift demodulation unit 202 which restores the converted and input digital broadcasting signal to initial data according to the first control signal CS1 of the controller 219; a forward direction error correcting unit 203, which corrects a carrier data format based on residue information, wherein the carrier data is demodulated and input from the quadrature phase shift demodulation unit 202 according to the first control signal CS1 which is generated by the controller 219, in order to correct a bit error, generated from an interference between adjacent channels and outputs the same as a packet unit; a reverse multiplexing unit 204 which reverse multiplexes the error-corrected and input carrier data format to video data and audio data, according to the third control signal CS3; an MPEG audio/video process unit 206 which respectively MPEG processes the video data and the audio data, which are reverse multiplexed and input, according to the fourth control signal CS4 of the controller 219, and determines whether to output the video data and audio data, which are respectively MPEG processed; and an additional information process unit 205 which determines whether to generate additional information, according to the fourth signal CS4 of the controller 219.

The digital broadcasting receiver also includes a synchronous separation unit 207 which separates the synchronous signal from the analog broadcasting signal of the corresponding analog broadcasting channel, which channel is tuned by the air tuner 200b of the tuning unit 200, and outputs the same; a video encoder unit 208 which encodes the video data, output by the MPEG audio/video process unit 206, and the additional information input from the additional information process unit 205, according to fifth control signal CS5 of the controller 219 and the synchronous signal, separated by and input from the synchronous separation unit 207, and transmits the same via an image output terminal 218; a video mix unit 209 which overlaps the additional information, encoded and input by the sixth control signal CS6, with the analog video signal, tuned and input from the air tuner 200b, and outputs a composite image signal via an image output terminal 216 when the analog broadcasting channel is selected. The video mix unit 209 selects the video signal and the additional information, encoded and input according to the sixth control signal CS6, and transmits to the television receiver via the image output terminal 216 when the digital broadcasting channel is selected; a digital/analog converting unit 210 which converts the audio signal, input from the MPEG audio/video process unit 206, to the analog signal and outputs the same; an audio selection unit 211 which selects the converted analog audio signal and the audio signal, tuned and input by the air tuner 200b, according to the seventh control signal CS7, and transmits the same to the television receiver.

Moreover, if the outputting of a luminance/color (Y/C) signal in addition to the outputting of the composite image signal is necessary, the basic digital/analog broadcasting receiver further includes: a second luminance/color separation unit 215 which separates the composite image signal, with respect to the digital broadcasting and the analog broadcasting, input from the video mix unit 209, into a luminance Y signal and a color C signal, and transmits the same; a first luminance/color separation unit 212 which separates the analog composite image signal which is tuned and input by the air tuner 200b into the luminance Y signal and the color C signal; and first and second switching units 213 and 214 which change the separated and input luminance Y signal and the color C signal to a continuous signal, according to the eighth control signal CS8, and transmitting the same.

The digital broadcasting receiver for receiving the analog broadcasting in the above-mentioned manner selectively receives analog broadcasting signal and the digital broadcasting via signal an air antenna cable or a parabolic antenna in accordance with the above-mentioned operation.

First, when the user turns on the digital broadcasting receiver and the television receiver, the controller 219 of the digital broadcasting receiver generates the fourth control signal CS4, controls the additional information process unit 205 and generates graphic data with respect to the additional information.

The graphic data, generated from the additional information process unit 205, is transmitted as the luminance/color (Y/C) signal via the video encoder unit 208 and the image output terminal 218 and simultaneously, transmitted to the television receiver via the video mix unit 209 and the image output terminal 216, which will be described later, and displayed on a display screen.

Thus, when the user selects the digital broadcasting channel from the graphic data of the display screen using a remote controller 219 or a key on the television set, the controller 219 generates the control signals CS1 through CS3 and CS5 through CS7.

The second control signal CS2, generated from the controller 219, controls the digital broadcasting tuner 200a of the tuning unit 200 which receives the digital broadcasting signal of the corresponding digital broadcasting channel via the parabolic antenna.

The analog broadcasting signal of the carrier signal, which is quadrature phase shift key modulated and received via the digital broadcasting tuner 200a, is digitalized via the analog/digital converting unit 201 and input to the quadrature phase shift demodulation unit 202.

The quadrature phase shift demodulation unit 202 demodulates the converted and input digital broadcasting signal to the initial data according to the first control signal CS1, generated from the controller 219.

The carrier data (initial data), restored by the quadrature phase shift demodulation unit 202, is input into the reverse multiplexing unit 204 after the forward direction error correcting unit 203 corrects the error which is generated by the interference between the adjacent channels according to the first control signal CS1 of the controller 219.

The reverse multiplexing unit 204 reverse multiplexes the multiplexed and input carrier data to the video data and the audio data according to the third control signal CS3, generated by the controller 219, and supplies the same to the MPEG audio/video process unit 206.

The MPEG audio/video process unit 206 respectively MPEG processes the video data and the audio data, which are reverse multiplexed and input, according to the fourth control signal CS4 of the controller 219 and respectively supplies the MPEG audio data to the digital/analog converting unit 210 and the MPEG video data to the video encoder unit 208.

Then, the additional information process unit 205 supplies the additional information to the video encoder unit 208 according to the fourth control signal CS4 of the controller 219.

Accordingly, the video encoder unit 208 analogizes the MPEG video data and the additional information, which are input from the MPEG audio/video process unit 206, according to the fifth control signal CS5, transmits the same via the image output terminal 218 and simultaneously, supplies the same to the video mix unit 209.

The video mix unit 209 mixes the analogized composite image signal and the additional information, which are encoded and input by the sixth control signal CS6 of the controller 219, and supplies the same to the television receiver via the image output terminal 216. Moreover, the digital/analog converting unit 210 analogizes the MPEG audio data, which is input by the MPEG audio/video process unit 206, and supplies the same to the audio selection unit 211.

The audio selection unit 211 selects the audio signal with respect to the analogized and input digital broadcasting according to the seventh control signal CS7 of the controller 219 and supplies the same to the television receiver via the audio output terminal 217. Accordingly, the user can view the digital broadcasting which displays the additional information via the color cathode ray tube.

In the mean time, in the above-mentioned manner, in receiving the analog broadcasting via the digital broadcasting receiver for receiving the digital broadcasting, when the analog broadcasting channel number in the image graphic data of the television receiver is selected by using the remote controller 219 or the key on the television receiver set, the second or the fourth through the seventh control signals CS2, CS4, CS5, CS6 and CS7, which have a different information value with respect to the receiving of the digital broadcasting, are generated.

Then, the second control signal CS2, generated from the controller 219, controls the air tuner 200b of the tuning unit 200 and selects the corresponding analog broadcasting channel.

The analog broadcasting signal of the selected channel, that is the output composite image signal from the air tuner 200b, is separated into the synchronous signal by the synchronous separation unit 207 and input into the video encoder unit 208, and also separated into the video signal and the audio signal. The separated video signal is input into the video mix unit 209 and the separated audio signal is input into the audio selection unit 211, respectively.

In changing from the digital broadcasting to the analog broadcasting, by adjusting the phase between the synchronous signal, separated in the synchronous separation unit 207 and the synchronous signal according to the MPEG screen, that is the synchronous signal according to the video data screen of the channel in receiving the digital broadcasting, the jittering of the screen during changing the broadcasting is prevented. In other words, the synchronous signal from the composite image signal in the synchronous separation unit 207 is separated and the phase is adjusted to the digital broadcasting.

In changing from the digital broadcasting to the analog broadcasting, the MPEG audio data and the MPEG video data, prior to being processed by the MPEG audio/video process unit 206, are intercepted using the fourth control signal CS 4 of the controller 219 and only the additional information from the additional information process unit 205 is continuously supplied to the video encoder unit 208.

Accordingly, according to the fifth control signal CS5, the video encoder unit 208 analogizes the graphic data with respect to the additional information to the luminance Y signal and the color C signal, transmits the same via the image output terminal 218 and simultaneously supplies the same to the video mix unit 209.

Then, the video mix unit 209 overlaps the luminance/color signal, with respect to the encoded and input additional information from the video encoder unit 208, with the analog video signal which is tuned by the air tuner 200b, according to the sixth control signal CS6 of the controller 219, and outputs the composite image signal to the television receiver via the image output terminal 216.

Selectively, it is possible to map the information except for the transparency and so on, by using a video switching unit instead of using the video mix unit 209, onto the analog video signal and to supply the same to the television receiver.

Consequently, according to the seventh control signal CS7 of the controller 219, the audio selection unit 211 selects the analog audio signal which is tuned by the air tuner, and transmits the same to the television receiver via the audio output terminal 217. Accordingly, the MPEG screen, which has been receiving the digital broadcasting, is changed to the analog broadcasting screen. However, the additional information, such as on screen display information, is maintained without change.

In changing from receiving the analog broadcasting to receiving the digital broadcasting again, as mentioned in the foregoing, the analog broadcasting screen is changed to the MPEG screen of the digital broadcasting after synchronizing both phases.

And, selectively, to output the luminance Y signal and the color C signal in addition to the composite image signal, the first and the second luminance/color separation units 212 and 215 and the first and the second switching units 213 and 214 are additionally required, as shown in FIG. 2. And, the eighth control signal CS8 from the controller 219 is also required.

In other words, the second luminance/color separation unit 215 separates the luminance Y signal and the color C signal from the composite image signal with respect to the digital broadcasting or the analog broadcasting, which is mixed with the additional information and input by the video mix unit 209, and supplies the same to the television receiver.

The first luminance/color separation unit 212 separates the composite image signal with respect to the pure analog signal, which is input from the air tuner 200b, into the luminance signal and the color signal, and supplies the same to the first and the second switching units 213 and 214.

The first and the second switching units 213 and 214 change the luminance signal and the color signal, which are separated and input by the first luminance/color separation unit 212, to the continuous signal by the eighth control signal CS8 of the controller 219 and supply the same to the video cassette recorder or the television receiver.

In the mean time, in comparison with the prior art, in which the user can view the screen by MPEG processing the video signal and the audio signal of the digital broadcasting via the MPEG process unit of the digital broadcasting receiver, when the present invention uses the air tuner, video mix unit and the first and second switching units for receiving the analog broadcasting, the present invention can receive the analog broadcasting of which is transmitted by the air broadcasting or the cable broadcasting, in addition to the digital broadcasting.

Consequently, according to the present invention, by receiving the analog broadcasting and the digital broadcasting using one broadcasting receiver, the digital broadcasting receiver can receive the analog broadcasting and the digital broadcasting according to the selection of the video mix unit or the video selection unit. And by displaying the same additional information with respect to receiving the digital broadcasting which receives the analog broadcasting, the present invention provides convenience in usage and compatibility with the television receiver.

It is clearly understood through the detailed descriptions that the apparatus for receiving the analog broadcasting of the digital broadcasting receiver can receive the air broadcasting or the analog cable broadcasting by using one digital broadcasting receiver. Also, the digital broadcasting receiver for receiving the analog broadcasting can provide the convenience in usage and the compatibility with the television receiver by adapting the basic analog tuning function without increasing the cost.

As the terms mentioned in the specification are determined based upon the function of the present invention, and they can be changed according to an artisan's intention or usual practice, the terms should be determined considering the overall contents of the specification of the present invention.

While there have been illustrated and described what are considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

What is claimed is:

1. A method of receiving and processing a broadcasting signal, the method comprising:
receiving a digital broadcasting signal;
generating additional information according to graphic information of the digital broadcasting signal;
MPEG processing a video signal of the digital broadcasting signal and an audio signal of the digital broadcasting signal;
mixing the additional information with the MPEG processed video signal;
transmitting the additional information with the MPEG processed video signal; and
transmitting the MPEG processed audio signal.

2. The method of claim 1, further comprising:
determining whether an analog broadcasting channel is selected; and
if the analog broadcasting channel is selected,
receiving an analog broadcasting signal,
mixing the additional information with a video signal of the analog broadcasting signal,
transmitting the additional Information with the video signal of the analog broadcasting signal, and
transmitting an audio signal of the analog broadcasting signal.

3. The method of claim 2, wherein:
the transmitting of the additional information with the video signal of the analog broadcasting signal comprises transmitting the additional information with the video signal of the analog broadcasting signal as a composite image signal, and
the method further comprises transmitting the additional information with the video signal of the analog broadcasting signal as separate luminance and color signals.

4. The method of claim 2, wherein, if the analog broadcasting channel is selected, synchronizing phases of the analog broadcasting signal with the digital broadcasting signal so as to prevent jittering from occurring in output video upon changing between the digital broadcasting signal and the analog broadcasting signal.

5. The method of claim 1, wherein:
the mixing comprises overlapping the additional information with the MPEG processed video signal,
the transmitting comprises transmitting the additional information with the MPEG processed video signal as a composite image signal, and
the method further comprises transmitting the additional information with the MPEG processed video signal as separate luminance and color signals.

6. The method of claim 1, further comprising de-multiplexing the digital broadcasting signal into the video signal, the audio signal and the graphic information.

7. The method of claim 1, wherein the generating of the additional information comprises generating a graphic and/or text signal according to the graphic Information of the digital broadcasting signal.

8. The method of claim 1, further comprising encoding the MPEG processed video signal and the additional information.

9. The method of claim 1, further comprising:
determining whether an analog broadcasting channel is selected; and
If the analog broadcasting channel is selected,
receiving an analog broadcasting signal,
generating additional information corresponding to the analog broadcasting signal,
mixing the additional information corresponding to the analog broadcasting signal with a video signal of the analog broadcasting signal,
transmitting the additional information with the video signal of the analog broadcasting signal, and
transmitting an audio signal of the analog broadcasting signal.

10. A broadcasting receiver to receive a broadcasting signal, comprising:
a tuning unit to receive a digital broadcasting signal;
an additional information processing unit to generate additional information according to graphic information of the digital broadcasting signal;
a processing unit to MPEG process a video signal of the digital broadcasting signal and an audio signal of the digital broadcasting signal, and to mix the MPEG processed video signal with the additional information for transmitting the mixed signal for display.

11. The broadcasting receiver of claim 10, wherein, in response to an analog broadcasting channel being selected:
the tuning unit receives an analog broadcasting signal, and
the processing unit mixes a video signal of the analog broadcasting signal with the additional information for transmitting of the mixed signal for display.

12. The broadcasting receiver of claim 11, wherein, in response to the analog broadcasting channel being selected, the processing unit synchronizes phases of the analog broadcasting signal with the digital broadcasting signal so as to prevent jittering from occurring in output video upon changing between the digital broadcasting signal and the analog broadcasting signal.

13. The broadcasting receiver of claim 11, wherein the additional information mixed with the video signal of the analog broadcasting signal is a same graphic and/or text signal mixed with the video signal of the digital broadcasting signal.

14. The broadcasting receiver of claim 11, further comprising a synchronous separation unit to extract a synchronous signal from the analog broadcasting signal, wherein the processing unit synchronizes the additional information with the video signal of the analog broadcasting signal in accordance with the synchronous signal.

15. The broadcasting receiver of claim 10, further comprising a luminance/color separation unit to separate the mixed signal into a luminance and color signals.

16. The broadcasting receiver of claim 10, further comprising a reverse multiplexing unit to de-multiplex the digital broadcasting signal into the video signal, the audio signal and the graphic information.

17. The broadcasting receiver of claim 10, wherein, in response to an analog broadcasting channel being selected:
the tuning unit receives the analog broadcasting signal, and
the processing unit mixes a video signal of the analog broadcasting signal with additional information corresponding to the analog broadcasting signal for transmitting of the mixed signal for display.

18. A method of receiving and processing a broadcasting signal, the method comprising:
selectively receiving a second digital broadcasting signal, after previously tuning and receiving a first analog broadcasting signal, or a second analog broadcasting signal, after previously tuning and receiving a first digital broadcasting signal; and
processing the second digital broadcasting signal or the second analog broadcasting signal selectively received, wherein the processing comprises synchronizing phases of the second digital broadcasting signal and the first analog broadcasting signal, or the second analog broadcasting signal and the first digital broadcasting signal, respectively.

19. The method of claim 18, wherein the synchronizing comprises matching the phases of the first digital broadcasting signal and the second analog broadcasting signal, or the first analog broadcasting signal and the second digital broadcasting signal so as to prevent jittering from occurring in output video upon changing selection between the first digital broadcasting signal and the second analog broadcasting signal, or between the first analog broadcasting signal and the second digital broadcasting signal, respectively.

20. The method of claim 18, wherein, in response to receiving the second analog broadcasting signal, the method further comprises:
generating additional information corresponding to the selected second analog broadcasting signal according to graphic information of the first digital broadcasting signal; and
outputting the processed second analog broadcasting signal with the additional information.

21. The method of claim 20, wherein the additional information corresponding to the second analog broadcasting signal is same as additional information corresponding to the first digital broadcasting signal.

22. The method of claim 20, wherein the generating comprises generating a graphic and/or text signal corresponding to the selected second analog broadcasting signal according to the graphic information of the first digital broadcasting signal.

23. The method of claim 18, further comprising:
generating additional information corresponding to the selected second digital broadcasting signal or the second analog broadcasting signal; and
outputting the processed second digital broadcasting signal or the second analog broadcasting signal with the corresponding additional information.

24. A method of maintaining additional information corresponding to a broadcasting signal in response to tuning and receiving an analog broadcasting signal after previously tuning and receiving a digital broadcasting signal, the method comprising:
receiving an analog broadcasting signal, after previously receiving a digital broadcasting signal;
separating the analog broadcasting signal into an analog broadcasting video signal and an analog broadcasting audio signal;
generating additional information according to graphic information corresponding to the digital broadcasting signal;
transmitting the additional information with the analog broadcasting video signal; and
transmitting the analog broadcasting audio signal separated from the analog broadcasting signal.

25. The method of claim 24, wherein the additional information is a same graphic and/or text signal transmitted with a video signal of the digital broadcasting signal.

26. The method of claim 24, further comprising encoding the additional information and overlapping the encoded additional information with the analog broadcasting video signal.

27. The method of claim 24, wherein:
the separating comprises extracting a synchronous signal from the received analog broadcasting signal, and
the method further comprises synchronizing the additional information with the analog broadcasting video signal in accordance with the synchronous signal.

28. The method of claim 24, further comprising synchronizing phases of the analog broadcasting signal with the digital broadcasting signal so as to prevent jittering from occurring in output video upon changing between the digital broadcasting signal and the analog broadcasting signal.
